(19) United States
(12) Patent Application Publication
(10) Pub. No.: US 2008/0159584 A1
(43) Pub. Date: Jul. 3, 2008

(54) INFORMATION PROCESSING APPARATUS AND INFORMATION PROCESSING METHOD

(75) Inventors: Kazue Kaneko, Kawasaki-shi (JP); Tsuyoshi Yagisawa, Kawasaki-shi (JP); Yasuo Okutani, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/673,491

(22) Filed: Feb. 9, 2007

(30) Foreign Application Priority Data
Mar. 22, 2006 (JP) 2006-079057

(51) Int. Cl. G06K 9/00

(52) U.S. Cl. 382/100; 348/231.3

(57) ABSTRACT

An information processing apparatus includes an image acquisition unit configured to acquire image data, an output unit configured to select a question from a plurality of questions stored on a storage element and output the selected question, a response acquisition unit configured to acquire response contents responding to the question, and a storage unit configured to relate the image data acquired by the image acquisition unit to the response acquired by the response acquisition unit, and store the related data and contents.

### BACKGROUND OF THE INVENTION

1. Field of the Invention

The present invention relates to an information processing apparatus configured to relate image data to character data or voice data and store the related data.

2. Description of the Related Art

With the popularization of digital cameras, album software for electronically recording photographs and managing the recorded photographs on a personal computer (PC) has been used. Some of the album software can record metadata such as image capture date and time about a still image, and users can attach comments as character information. Other album software has a feature to reproduce voice recorded before or after the image capture when browsing the picture. Further, some album software has a feature to play music in reproducing photographs as slide show. Some DVD recorders also have a feature to play music in reproducing photographs taken from a digital camera as slide show. Conventionally, the still images have been merely printed out. However, as described above, now the still images can be reproduced and enjoyed together with voice when displayed. Accordingly, techniques to create a memo such as voice data or character data for the image data become increasingly important.

In order to attract a subject's attention and give a signal in capturing an image, some conventional cameras have a function of customizing its shutter sound. For example, in Japanese Patent Laid-Open No. 09-163205, users can record a signal to start an image capture of a subject and instructions for the device usage, and reproduction can be performed by a switch different from a shutter.

In Japanese Patent Laid-Open No. 2002-107807, sounds for attracting attention of a baby or an animal are provided, and corresponding to an image capture mode, the sound is reproduced. This function serves to attract attention of the shooting subject or the photographer by reproducing the sound in order to increase the quality of the pictures taken, and does not aim to attach sounds to the pictures.

On the other hand, Japanese Patent Laid-Open No. 62-092688 discusses an intercom that reproduces a message to announce absence from home, and records a still image and business of the visitor correspondingly with each other. In this example, the visitor has some business and the contents to be spoken can be surmised. Therefore, the reproduced message announcing absence from home is used only for providing the visitor timing to speak. Accordingly, only one message is enough for reproduction, and it is not necessary to record the message. Accordingly, the reproduced message is not recorded and only the still image and the recorded business are recorded.

Even if the function for storing the image data and the voice data correspondingly is provided, by the reason that the subject often cannot speak anything when an image is actually captured, an opportunity to use the function has been limited. Although an instruction as a cue is prepared, when a question such as “May I help you?” or “Please leave a message.” is given at the time of shooting as in answer phones, the caller is bewildered and cannot decide what to say. Such a problem is yet to be solved. Accordingly, a specific question depending on the situation has to be provided.

### SUMMARY OF THE INVENTION

According to an aspect of the present invention, an information processing apparatus includes an image acquisition unit configured to acquire image data, an output unit configured to select a question from a plurality of questions stored on a storage element and output the selected question, a response acquisition unit configured to acquire response contents responding to the question, and a storage unit configured to relate the image data acquired by the image acquisition unit to the response contents acquired by the response acquisition unit, and store the related data.

According to yet another aspect of the present invention, an information processing apparatus includes a storage unit configured to store image data, a question related to the image data, and response contents corresponding to the question, a display control unit configured to associate the image data with the question related to the image data stored on the storage unit, and display the associated data and question, and a presentation unit configured to present the response contents corresponding to the question displayed by the display control unit based on an instruction.

According to yet another aspect of the present invention, an information processing method includes acquiring image data, selecting a question from a plurality of questions stored on a memory and outputting the selected question, acquiring response contents responding to the question, and relating the acquired image data to the acquired response contents and storing the related data.

According to yet another aspect of the present invention, an information processing method includes associating image data with a question related to the image data stored on a storage unit configured to store the image data, the question related to the image data, and response contents corresponding to the question and displaying the related data and question, and presenting the response contents corresponding to the displayed question based on an instruction.

According to still yet another aspect of the present invention, a computer-readable storage medium is provided containing computer-executable instructions for processing information in an information processing apparatus. The computer readable medium includes computer-executable instructions for associating image data with a question related to the image data stored on a storage unit configured to store the image data, the question related to the image data, and a response corresponding to the question, and further displaying the related data and question; and computer-executable instructions for presenting the response contents corresponding to the displayed question based on an instruction.

Additionally, according to yet another aspect of the present invention, a computer-readable storage medium is provided containing computer-executable instructions for processing information in an information processing apparatus. Here, the computer readable medium includes computer-executable instructions for acquiring image data; computer-executable instructions for selecting a question from a plurality of questions stored on a memory and outputting the selected question; computer-executable instructions for acquiring a response responding to the output question; and computer-executable instructions for relating the acquired image data to the acquired response, and storing the related data on a memory.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating an example digital camera according to a first exemplary embodiment.

FIG. 2 is a flowchart illustrating an example flow of the processing of the first exemplary embodiment.

FIG. 3 illustrates an example of a question selection rule according to an aspect of the present invention.

FIG. 4 illustrates an example of questions according to an aspect of the present invention.

FIG. 5 is a block diagram illustrating an example information processing apparatus according to a second exemplary embodiment.

FIG. 6 is a flowchart illustrating an example flow of the processing of the second exemplary embodiment.

FIG. 7 is a block diagram illustrating an example information processing apparatus according to a third exemplary embodiment.

FIG. 8 is a flowchart illustrating an example flow of the processing of the third exemplary embodiment.

FIG. 9 illustrates an example of display of still images according to the third exemplary embodiment.

FIG. 10 illustrates an example of reproduction of a voice corresponding to the still image illustrated in the third exemplary embodiment.

### DETAILED DESCRIPTION OF THE EMBODIMENTS

Various exemplary embodiments, features, and aspects of the invention will be described in detail below with reference to the drawings.

### First Exemplary Embodiment

In the first exemplary embodiment, as an example, a digital camera is described as an information processing apparatus according to the present invention.

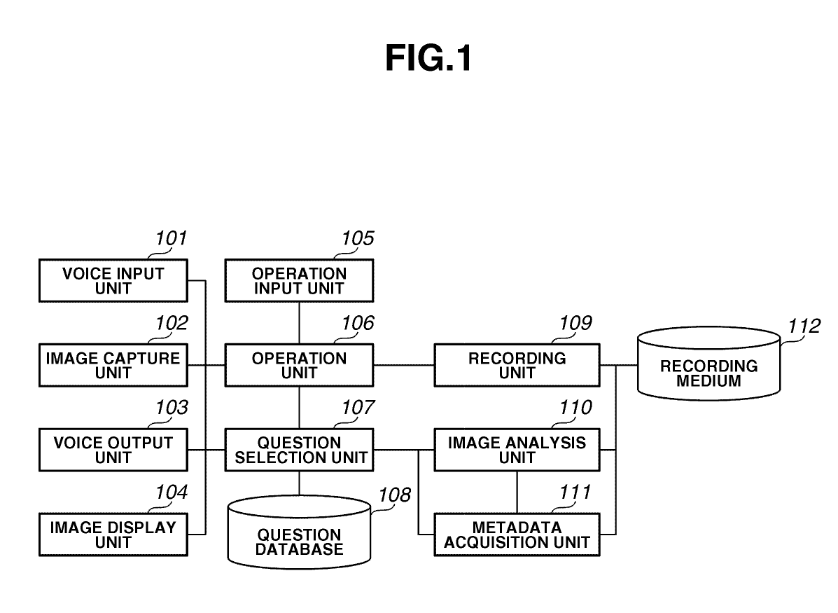

FIG. 1 illustrates a block diagram of the digital camera according to the first exemplary embodiment. A voice input unit 101 inputs a voice responding to a question. An image capture unit 102 captures a still image. A voice output unit 103 outputs a question voice or a response voice. An image display unit 104 carries out a preview before image capture or a view after the image capture. An operation input unit 105 inputs an operation performed by a user, for example, an image capture operation or an image reproduction. An operation unit 106 carries out an operation in response to an instruction by the user. A question selecting unit 107 selects a question from a question database (DB) 108. The question DB 108 stores question sentences and question selection rules. A recording unit 109 records a still image, a question and a response. An image analysis unit 110 analyzes a still image and extracts characteristics of a subject. A metadata acquisition unit 111 acquires metadata, for example, an image capture date and time, an image capture place, or an image capture history. A recording medium 112 records a still image, a question, and a response. These processing units carry out the processing under the control of a control unit (not shown).

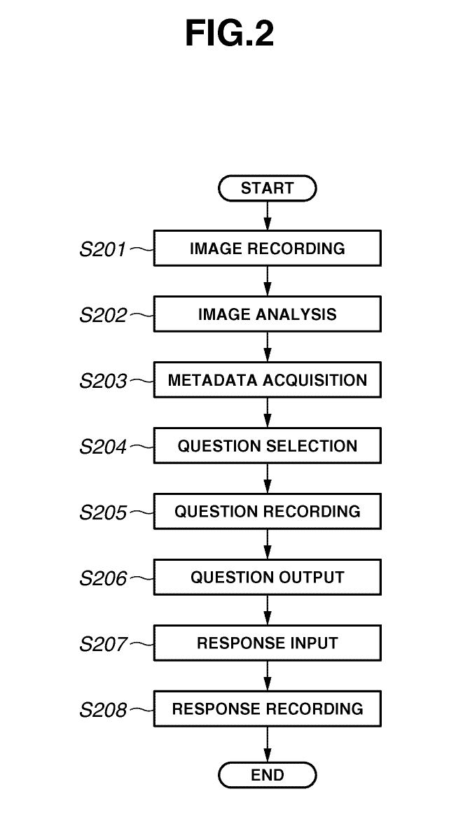

FIG. 2 is a flowchart illustrating the processing carried out in the digital camera according to the first exemplary embodiment. The flow of the flowchart is executed, for example, according to a control program recorded on the recording unit 109.

In this exemplary embodiment, an interview mode for asking a question and storing the response is provided as an image capture mode. The processing is started when an image is captured in the mode. First, at step S201, the digital camera captures a still image and records the captured image. At step S202, the digital camera analyzes the image and extracts characteristics of the shooting subject. At step S203, the digital camera acquires metadata such as a time of the image capture, image capture parameters, or an image capture history. In apparatuses that have a location detection function, location information can be acquired.

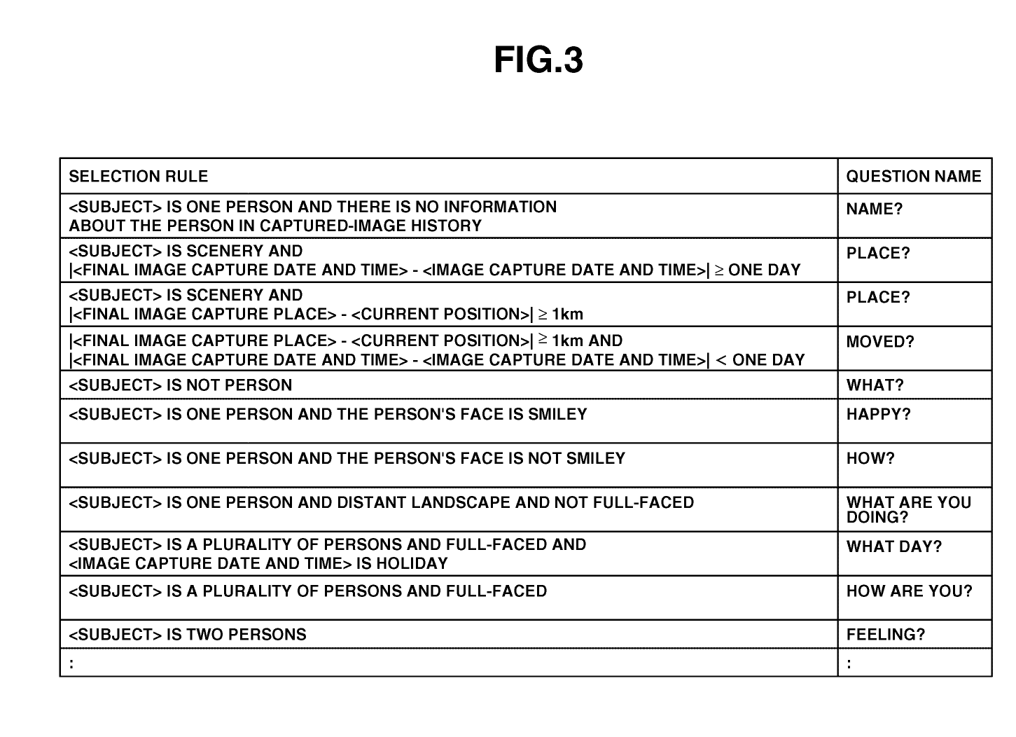

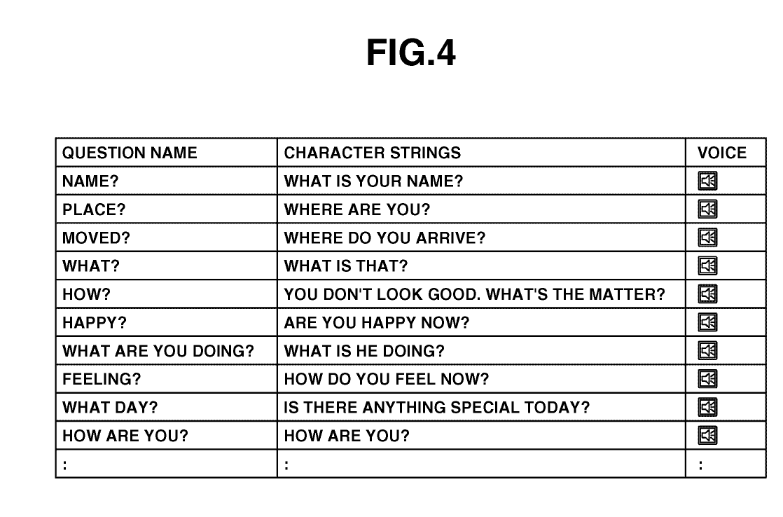

At step S204, using the characteristics of the subject or information of the metadata, the digital camera selects a question according to the question selection rule stored in the question DB 108. FIG. 3 illustrates an example of the question selection rule, and FIG. 4 illustrates an example of the questions. According to the question selection rule, a question is selected using both the characteristics of the subject and the information of the metadata, or either the characteristics of the subject or the information of the metadata.

Then, at step S205, the digital camera relates the selected question to the captured still image and records the related data and image. At step S206, the digital camera outputs the question. The digital camera takes out voice data of corresponding question name and reproduces the voice. However, presentation of the question can also be performed in characters. In the case of the characters, the digital camera displays the characters on the image display unit 104.

At step S207, the digital camera receives a response. In this case, the digital camera receives the response voice for a predetermined period of time. When the predetermined period of time has passed, at step S208, the digital camera relates the response voice to the captured still image, and records the response voice. In this case, the digital camera can be configured to recognize the response voice and record the voice recognition result.

In FIG. 2, at step S205, the digital camera relates the question to the still image and records the data. However, without recording the question, it is also possible to record only the response voice at step S208.

As described above, the characteristics of the subject or the information of the metadata are used to select the question, and the response contents are stored correspondingly with the question. Thus, a user can be encouraged to attach an appropriate memo.

### Second Exemplary Embodiment

In the first exemplary embodiment, as an example, the voice data is recorded when the image is captured by the digital camera. In the second exemplary embodiment, a question and a response are attached to a still image captured in advance.

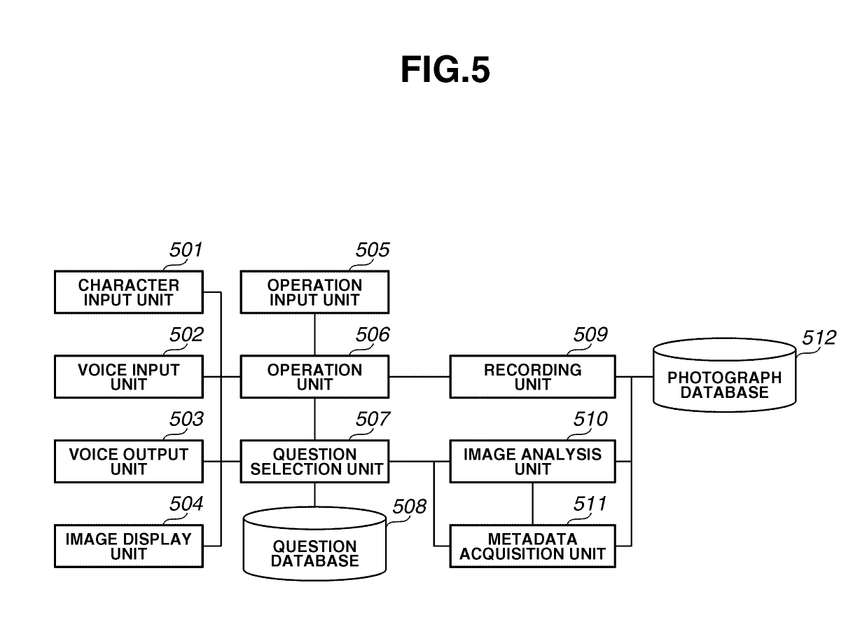

FIG. 5 is a block diagram illustrating an information processing apparatus according to the second exemplary embodiment. A character input unit 501 inputs a character string responding to a question. A voice input unit 502 inputs a response voice to the question. A voice output unit 503 outputs the question voice or the response voice. An image display unit 504 displays a still image or a question character string. An operation input unit 505 inputs an operation executed by the user such as an image selection or a comment attachment. An operation unit 506 executes an operation in response to an instruction from the user. A question selecting unit 507 selects a question from a question DB 508. The question DB 508 stores questions and question selection rules. A recording unit 509 records a still image, a question and a response. An image analysis unit 510 analyzes a still image and extracts characteristics of a subject. A metadata acquisition unit 511 acquires metadata, for example, an image capture data and time, an image capture place, or an image capture history. A photograph DB 512 stores a still image, a question, a response, and metadata. These processing units carry out the processing under the control of a control unit (not shown).

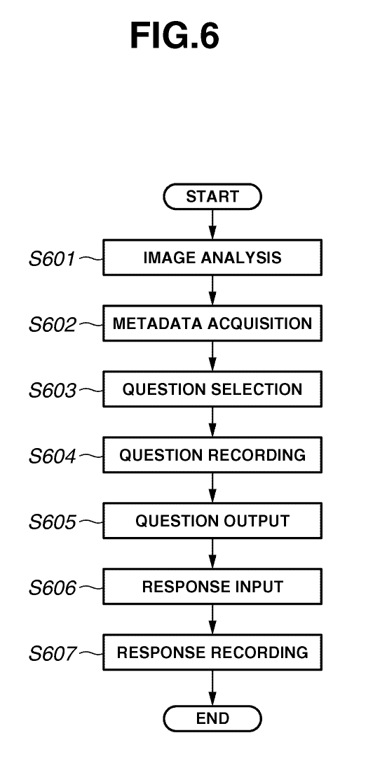

FIG. 6 is a flowchart illustrating a flow of the processing of the second exemplary embodiment. The flow can be executed, for example, according to a control program recorded on the recording unit 509.

The processing starts when still images captured by the digital camera are stored on the photograph DB 512, and in order to attach a comment, the user selects a still image to which a comment such as a question or a response to the still image is not attached.

At step S601, the information processing apparatus analyzes the image taken out from the photograph DB 512 and extracts characteristics of the subject. At step S602, the information processing apparatus acquires metadata such as a time of the image capture, a location, image capture parameters, or an image capture history from the photograph DB 512. At step S603, the information processing apparatus, using the characteristics of the subject or information of the metadata, selects a question according to a question selection rule stored on the question DB 508. The question rules and the question contents are similar to those illustrated in FIGS. 3 and 4 of the first exemplary embodiment.

Then, at step S604, the information processing apparatus relates the selected question to the captured still image and records the data. At step S605, the information processing apparatus outputs the question. The information processing apparatus displays a character string of corresponding question name. However, the information processing apparatus can also output a voice.

At step S606, the information processing apparatus inputs the response. The information processing apparatus can input the response as a character string using a character input method or can input a response voice. In the case of the voice response, the response can be input after a predetermined period of time has passed when the question is output, or the user can instruct the start and end of the input. At step S607, the information processing apparatus relates the characters or a voice of the response to the still image and records the data.

With such a configuration, when the voice or character data is attached to the image data recorded on the database (DB), a user can be encouraged to attach an appropriate memo.

### Third Exemplary Embodiment

In the above exemplary embodiments, as an example, the voice data or character data is associated with the image data and stored. In the third exemplary embodiment, a processing of a still image in which a question and a response are associated with each other, will be described.

In a case of still images, the contents of the images can be recognized even if a plurality of images is simultaneously displayed. However, in a case of voices, clarity decreases if a plurality of voices is simultaneously reproduced. Accordingly, the voices have to be reproduced one by one. Conventionally, if the plurality of images is simultaneously presented, for example, each voice is reproduced in order. Alternatively, voice marks are provided to indicate that the voices are attached, and the voices can be reproduced in response to an instruction by the user. On the other hand, it is not possible to know what is recorded until the voice is actually reproduced. When the voice is actually reproduced, if a user finds that the contents of the voice are not interesting and disappointed, the user may lose his/her interest in reproducing the remaining contents. Accordingly, something is necessary which can be a hint about the contents of the voice.

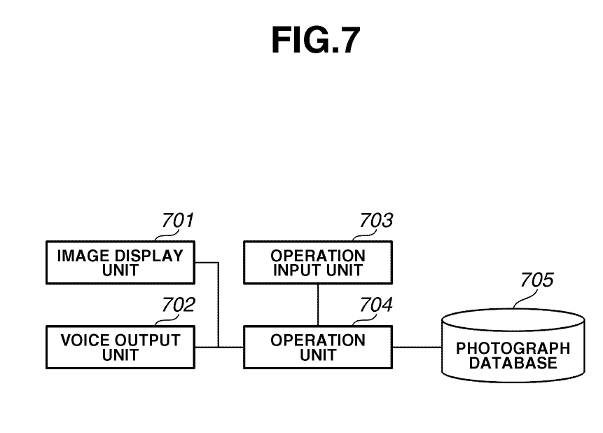

FIG. 7 is a block diagram illustrating an information processing apparatus according to the third exemplary embodiment. An image display part 701 enables a view of a still image. A voice output unit 702 outputs a voice of a question or a response. An operation input unit 703 inputs an operation executed by the user such as an image reproduction. An operation unit 704 executes an operation in response to an instruction by the user. A photograph DB 705 stores still images, questions, responses, and metadata.

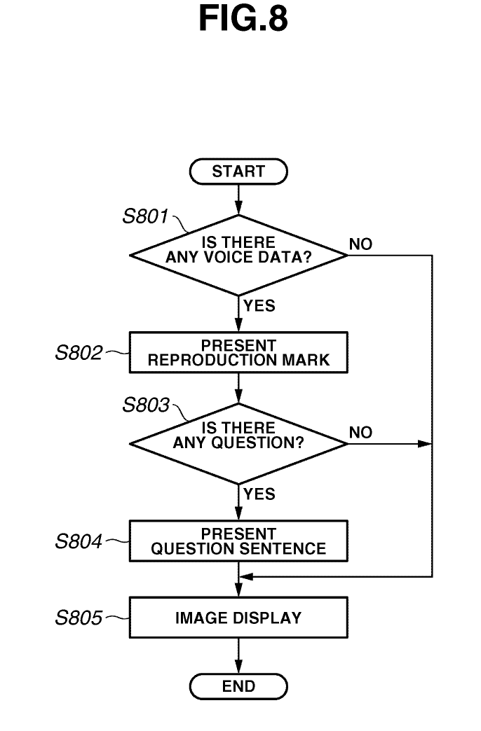

FIG. 8 is a flowchart illustrating a flow of the processing of the third exemplary embodiment. In the description, the processing of the still image display will be limited to display of one still image. The processing starts when the still image is selected for display.

At step S801, the information processing apparatus determines whether any associated response voice data exists. If the data does not exist, the flow proceeds to step S805. If the data exists (YES at step S801), at step S802, the information processing apparatus presents a voice reproduction mark. At step S803, the information processing apparatus determines whether any associated question exists. If the associated question does not exist, the flow proceeds to step S805. If the associated question exists (YES at step S803), at step S804, the information processing apparatus presents a question character string. Here, the question character string can be displayed or a voice can be output. Finally, at step S805, the information processing apparatus displays the image. The image, the reproduction mark, and the character string are arranged so that their association can be understood.

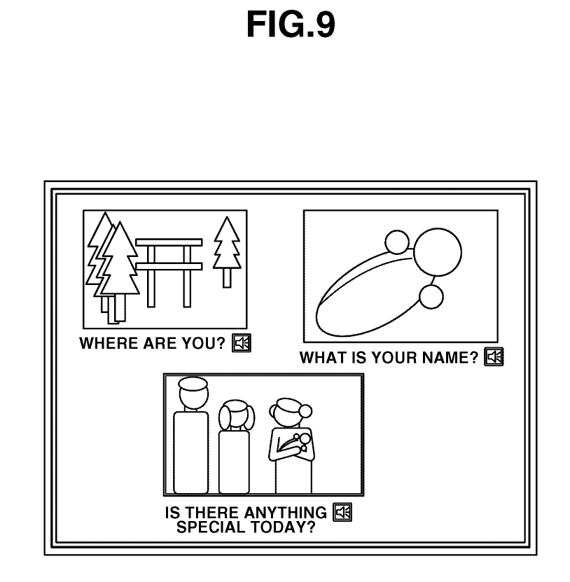

FIG. 9 illustrates an example of the display of the still images according to the third exemplary embodiment. In the drawing, the above-described processing is carried out to three still images, and the all images are arranged and displayed. In lower parts of the pictures, the question strings and the voice reproduction marks are displayed respectively.

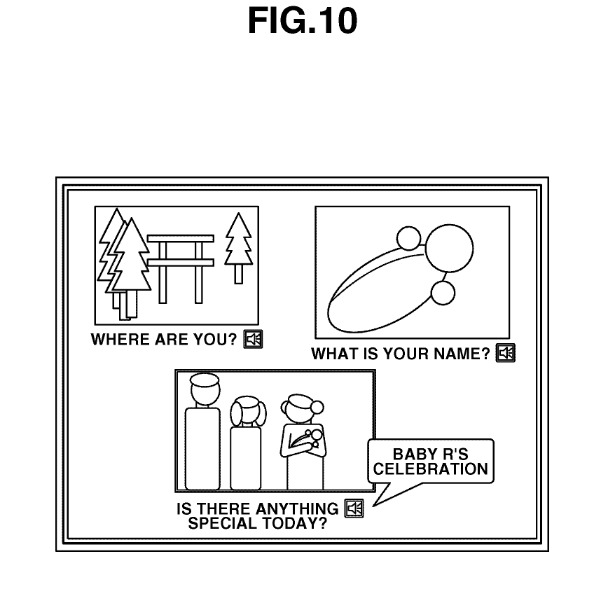

FIG. 10 illustrates an example of reproduction of the voice corresponding to the still images illustrated in the third exemplary embodiment. In the exemplary embodiment, the user selects the lower picture and reproduced the voice. The part in the dialogue balloon is not displayed but output as a voice.

As described above, the question sentence is simultaneously presented at the time of browsing the image data. Accordingly, the user can use the question sentence in deciding whether to reproduce the voice response, and effective image data browsing can be realized.

### Other Exemplary Embodiments

In the first exemplary embodiment, after the image is recorded, the output of the question and the input of the response are carried out. However, the image can also be captured before the question, during the question, after the question, during the response, or after the response.

Further, in the first exemplary embodiment, the image recording, the question recording, and the response recording are automatically executed as a series of operations. However, each processing can be executed in response to the instruction by the user.

Furthermore, in the first exemplary embodiment, the input of the response is carried out within the predetermined period of time. However, alternatively, the input of the response can be finished after the voice is detected and the vocalization is completed, or in response to an instruction by the user.

Also, in the first exemplary embodiment, after the output of the question is completed, the input of the response voice is carried out. However, alternatively, the input of the response voice can be executed simultaneously with the start of the question.

Moreover, in the first exemplary embodiment, as an example, the response is given in voice. However, the response can be input in characters by providing a character input means to the digital camera. Additionally, in the first exemplary embodiment, the question is stored both in characters and voice, however, only the voice can be recorded. And still yet, the first exemplary embodiment can include a unit for changing the volume of the question voice.

Further, the first exemplary embodiment can include a unit for specifying whether the one who responds is photographer or the subject. If the photographer responds, the volume of the question voice can be turned down or the question can be presented in characters. When the one who responds is the subject, if the subject is not a person, the photographer can respond, and a question corresponding to the photographer can be output.

Furthermore, in the first exemplary embodiment, the question is stored both in characters and voice. However, only the character string can be recorded and the voice can be generated using voice synthesis at the time of output.

And also, in the first exemplary embodiment, the example of the digital camera has been described. However, the present invention is not limited to the digital camera. Any apparatus which has an image capture unit, for example, a copying machine or a digital multi-function apparatus can be used. Moreover, apparatuses to which an external image capture unit can be connected can also be used.

In the second exemplary embodiment, the user selects the still image to which a comment is attached. However, still images with which any voice or character comment is not associated, can be detected at the system side, and the still images can be presented to the user to facilitate attachment of comments.

In the third exemplary embodiment, the character string and the reproduction mark are arranged in the exterior of the still image. However, the character string and the reproduction mark can be superimposed on the still image for display.

Furthermore, in the third exemplary embodiment, the display in a case where a response voice exists, has been described. However, if the response is given in characters, the response character string can be displayed. It is not necessary to display the question string.

Additionally, in the third exemplary embodiment, the question string is displayed. If voice synthesis is used, the response voice can be displayed in characters. Moreover, in the third exemplary embodiment, the question string is displayed. However, an icon which indicates the type of the question can be provided and displayed.

In the third exemplary embodiment, the display of the still image has been described in the configuration such that the image capture unit of the second exemplary embodiment is not included. However, in a case where the image capture unit of the first exemplary embodiment is included, the photograph DB can be replaced with a recording medium.

Further, in the above exemplary embodiments, as the method of question selection, the question selection rule is employed. However, the user can select a question from candidates as he chooses or questions can be randomly presented to the user. Further, a unit configured to record a new question in the apparatus and increase the number of questions can be provided. Also, a unit configured to increase the number of questions by externally downloading a new question can be provided.

Further, in the above exemplary embodiments, as an example of image data, mainly the still image has been described. However, a moving image can also be employed as the image data.

The present invention can also be achieved by providing the system or the apparatus with a storage medium which records a program code of software implementing the function of the exemplary embodiments and by reading and executing the program code stored in the storage medium with a computer of the system or the apparatus (the CPU or the MPU).

In this case, the program code itself, which is read from the storage medium, implements the function of the exemplary embodiments mentioned above, and accordingly, the storage medium storing the program code constitutes the present invention.

As the storage medium for supplying such program code, for example, a flexible disk, a hard disk, an optical disk, a magneto-optical disk, a CD-ROM, a CD-R, a magnetic tape, a nonvolatile memory card, and a ROM can be used.

In addition, the function according to the exemplary embodiments described above is implemented not only by executing the program code read by the computer, but also implemented by an OS (operating system) operating on the computer or the like which carries out a part of or the whole of the actual processing on the basis of the instruction given by the program code.

Further, in another aspect of the exemplary embodiments of the present invention, the function according to the exemplary embodiments described above can be implemented as described below. That is, after the program code read from the storage medium is written in a function enhancing board inserted in the computer or a memory which is provided in a function enhancing unit connected to the computer, the CPU and the like provided in the function enhancing board or the function enhancing unit carries out a part of or the whole of the processing to implement the function of the exemplary embodiments as described above.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2006-079057 filed on Mar. 22, 2006, which is hereby incorporated by reference herein in its entirety.

What is claimed:

1. An information processing apparatus comprising:
an image acquisition unit configured to acquire image data;
an output unit configured to select a question from a plurality of questions stored on a storage element and output the acquired question;
a response acquisition unit configured to acquire response responding to the outputted question; and
a storage unit configured to relate the image data acquired by the image acquisition unit and the response acquired by the response acquisition unit to each other, and to further store the related data.

2. The information processing apparatus according to claim 1, wherein the output unit selects the question from the plurality of questions stored on a storage element based on the image data acquired by the image acquisition unit, and outputs the selected question.

3. The information processing apparatus according to claim 1, wherein the output unit selects the question from the plurality of questions stored on a storage element based on metadata obtained when the image data is acquired by the image acquisition unit, and outputs the selected question.

4. The information processing apparatus according to claim 1, wherein the storage unit relates the image data acquired by the image acquisition unit, the question output by the output unit, and the response acquired by the response acquisition unit to each other, and then further stores the related data.

5. The information processing apparatus according to claim 1, further comprising a unit configured to store a question as a character string and display the question as the character string.

6. The information processing apparatus according to claim 1, further comprising a unit configured to store a question as a voice and reproduce the question as the voice.

7. The information processing apparatus according to claim 1, wherein the response acquisition unit acquires the response as a character string.

8. The information processing apparatus according to claim 1, wherein the response acquisition unit acquires the response as a voice.

9. The information processing apparatus according to claim 4, wherein the storage unit stores a question as a character string, and the information processing apparatus further comprises:
a display control unit configured to perform control to display the image data and the character string of the question contents related to the image data; and
a voice output unit configured to output the response corresponding to the image data displayed by the image control unit as a voice.

10. The information processing apparatus according to claim 3, wherein the metadata includes at least one of time data and positional data.

11. An information processing apparatus comprising:
a storage unit configured to store image data, a question related to the image data, and a response corresponding to the question;
a display control unit configured to associate the image data with the question related to the image data stored on the storage unit, and display the associated data and question; and
a presentation unit configured to present the response contents corresponding to the question displayed by the display control unit based on an instruction.

12. An information processing method comprising:
acquiring image data;
selecting a question from a plurality of questions stored on a memory and outputting the selected question;
acquiring a response responding to the output question; and
relating the acquired image data to the acquired response, and storing the related data on a memory.

13. The information processing method according to claim 12, wherein the selecting selects the question from a plurality of questions stored on the memory based on the acquired image data and outputs the selected question.

14. The information processing method according to claim 12, wherein the selecting selects the question from a plurality of questions stored on the memory based on a metadata obtained when the image data is acquired, and outputs the selected question.

15. The information processing method according to claim 12, wherein the relating relates the acquired image data, the output question, and the acquired response to each other, and stores the related data on a memory.

16. An information processing method comprising:
associating image data with a question related to the image data stored on a storage unit configured to store the image data, the question related to the image data, and a response corresponding to the question, and further displaying the related data and question; and
presenting the response contents corresponding to the displayed question based on an instruction.

17. A computer-readable storage medium containing computer-executable instructions for processing information in an information processing apparatus, the computer readable medium comprising:
computer-executable instructions for associating image data with a question related to the image data stored on a storage unit configured to store the image data, the question related to the image data, and a response corresponding to the question, and further displaying the related data and question; and
computer-executable instructions for presenting the response contents corresponding to the displayed question based on an instruction.

18. A computer-readable storage medium containing computer-executable instructions for processing information in an information processing apparatus, the computer readable medium comprising:
computer-executable instructions for acquiring image data;
computer-executable instructions for selecting a question from a plurality of questions stored on a memory and outputting the selected question;
computer-executable instructions for acquiring a response responding to the output question; and
computer-executable instructions for relating the acquired image data to the acquired response, and storing the related data on a memory.
